(19) United States
(12) Patent Application Publication
(10) Pub. No.: US 2026/0105901 A1
(43) Pub. Date: Apr. 16, 2026

(54) Harmonica Accordion

(71) Applicant: Nikita Verkhovsky, Petah Tikva (IL)

(72) Inventor: Nikita Verkhovsky, Petah Tikva (IL)

(21) Appl. No.: 18/911,284

(22) Filed: Oct. 10, 2024

(51) Int. Cl. G10D 7/14; G10D 9/035

(52) U.S. Cl. CPC G10D 7/14; G10D 9/035

(57) ABSTRACT

Harmonica accordion is a musical instrument, analogical in design to conventional harmonicas; however, it has qualitatively different wider opportunities for the performer. Namely, in addition to solo play it can be used as an independent accompanying instrument, as well as to combine solo play with accompaniment. Furthermore, it allows to accompany in many (or even all) keys, and for each key it has all chord functions. This is achieved due to an arrangement of notes that the reeds are tuned in, i.e. due to a specific tuning. In addition, the instrument uses an additional bass body to play bass tones for all the chords and flow voicing in the accompaniment. The instrument is

[symbol]

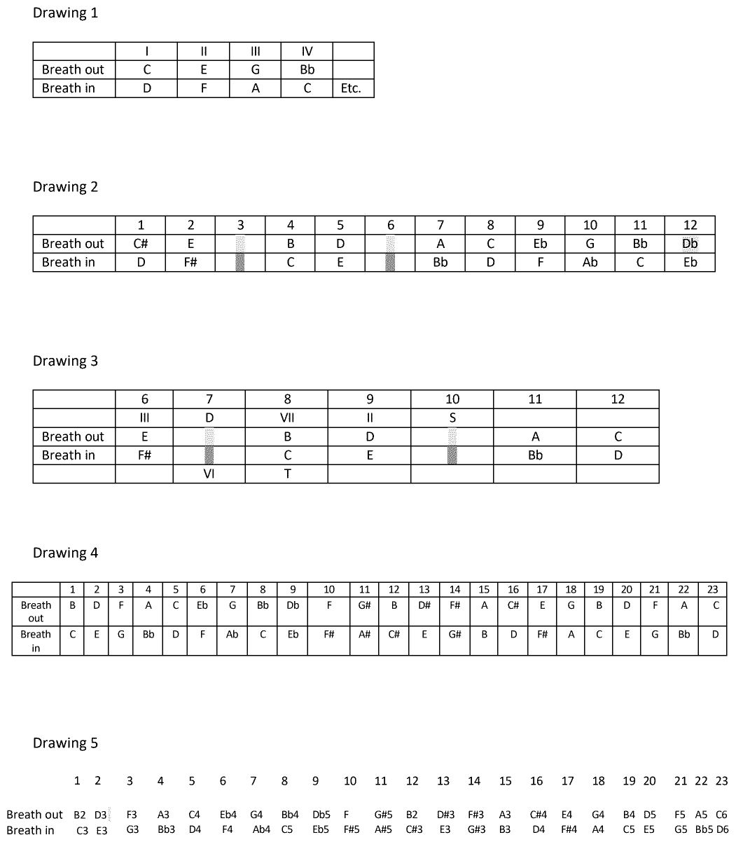

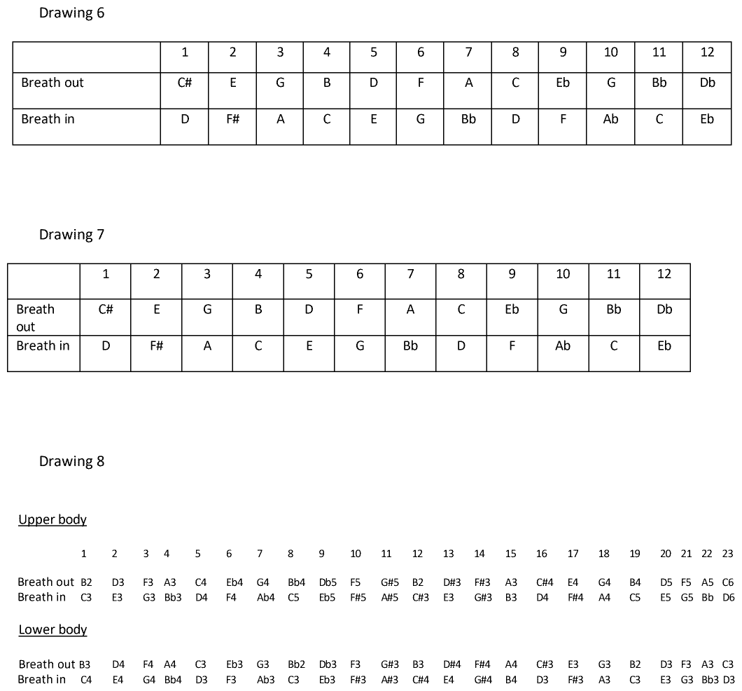

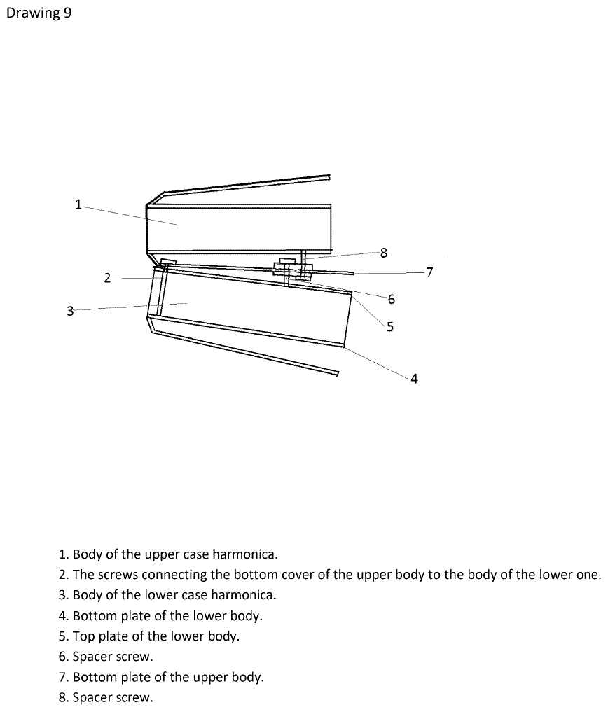

### CROSS-REFERENCE TO RELATED APPLICATIONS

Not applicable

### BACKGROUND OF THE INVENTION

Mouth harmonica is not a monophonic instrument. Its design allows taking three or more simultaneous sounds, i.e. chord. This quality of harmonica is already being used to a degree in the existing types of harmonicas. To understand benefits of my accompaniment goal on harmonica, and combining it with a solo playing, I would like to tell you a little about types of existing harmonicas, as well as the technique of playing them.

Harmonics can be classified into the following types:
1. Diatonic harmonica. When I say diatonic harmonica I mean its design and not its tuning. At the moment there are many harmonicas with alternative tuning which makes it difficult to distinguish between truly diatonic harmonica and harmonica with just modified tuning. For example, harmonica tuned in country key with increased tone in hole 5 on the inhale, strictly speaking, is not diatonic. Same can be said about harmonica is blues key with decreased tone in holes 3, 7 and 10 on the inhale. Nevertheless, using slang of the music world these two examples of harmonicas will be deemed diatonic. More advanced tune settings allow not only to take alteration subdominant chords, but also to play harmonica in several keys. But increasingly growing popular bend and overbends techniques allow you to take any chords, even on the simplest diatonic harmonica in Richter tune. Therefore, due to lack of better term I will call diatonic any harmonica with one body in form of a body, no slider, with one exhale reed and one inhale reed on each hole, and the basic playing technique of taking pure tones, bends and overbends chords or valve bends. My terminology may be inaccurate but I hope it is clear what I am trying to say.
2. Tremolo and octave harmonicas.
3. Chromatic harmonicas with button, and piano tuning.
4. Orchestral chord harmonicas, Bass-chord harmonicas and Bass harmonicas.
5. Harmonicas with keyboards can also be classed as another type.

Each type of harmonica has its pros and cons.
1. As the basis of my invention I have taken the diatonic harmonica, the most widespread type of harmonica in the world. This instrument, in contrast to all other types, gives the greatest opportunity in the management of sound as the reeds are located as close to the mouths of the performer as possible. In addition, this instrument is very simple, compact and cheap, which ensures its worldwide popularity. The downside here is the high complexity in the ability to master chromatic play (although it is possible), and extreme poverty of accompaniment features. On the classical harmonica tuned on the Richter system, you have the opportunity to take just three chords (tone, dominant and minor chord second stage). On some alternative tunings you can take a lot more chords. But in all these settings chord structure is not sufficient for a full accompaniment.
2. Tremolo and Octave are tuned harmonic diatonically, and therefore have the same drawbacks as the Classical harmonica-the inability to perform chromatic works and poverty in the accompaniment. However, thanks to a special technique of “tongue blocking” on them, one may mimic more complex accompaniment than tonic-dominant (e.g. playing in thirds), but still it can be done only within a single key, and even the simplest modulation on them are impossible. And, of course, the disadvantage of both types, the diatonic and tremolo-octave harmonicas is that for each tone executor must have a separate musical instrument.
3. Chromatic harmonica with slider allows solo performance in any key. But in terms of accompaniment are almost as poor as described above. The exception is chordomonica (http://www.patmissin.com/ffaq/q31.html). This is a harmonica with one or two sliders, which can take all chords in several keys. However, this is only possible using a slider, and on a regular diatonic harmonica, this setting makes no sense. Besides if we apply tuning method of harmonica accordionwith slider to a 12-hole instrument we can achieve all the chords in all the keys. Moreover, chordomonica have limited ability in a solo playing. I.e. the method of tuning I propose can provide a lot more.

Also, when speaking of harmonicas with a slider, it is necessary to mention the development of the company Suzuki, Suzuki Slide Chord Harmonica Chord56 SSCH-56. This instrument is designed specifically for accompaniment. It gives ability to the accompaniment of any complexity and for any keys. So as is the case with chordomonica, it is impossible to transfer this method of tuning to other types of harmonicas. For example, it will be meaningless for diatonic harmonica. Plus, Suzuki harmonica doesn't have solo performance abilities.

And general weakness of slider harmonicas is that their reeds located much further away from performer's mouths than in diatonic harmonicas, which has quite a strong effect on the management of sound. The sound of chromatic harmonica is very different to the sound of diatonic harmonica.

Chromatic harmonica with piano key is not suitable for accompaniment; it can only take a few chords.

Orchestral chord harmonicas enable full accompaniment in all keys. But it is quite bulky (more than half a metre) and very expensive. Moreover, they are absolutely not suitable for solo play.
4. And finally, harmonicas with a keyboard present ample opportunities for chromatic playing and accompaniment. But these instruments are closer to the accordion than a harmonica. Sound control in them is very limited, and playing technique has little to do with playing harmonica.
5. Harmonetta deserves to be mentioned separately. It was invented by firm Hohner in the 1960s. This is a mouth harmonica with 32 buttons that allow you to play solo as well as well as any chords up to eight sounds. However, due to the complexity of its playing technique, the high cost, as well as poor sound control, it has not taken off, and now is out of production.

Therefore, to summarise: the task of creating a harmonica which combines capabilities of solo playing and accompaniment still exists, and this task has been attempted to be solved and is being attempted as we speak. However, a simple and universal solution was not found yet. All of the above examples allow you either to play solo or to play accompaniment or are very difficult to produce and learn to play. And most importantly, there is no universal solution, i.e. it cannot be applied to all types of mouth harmonicas.

### BRIEF SUMMARY OF THEINVENTION

Harmonica accordion allows combining solo play and accompaniment without changing the design of the instrument or playing technique - it is achieved just by its specific tuning. The tuning of the instrument can also be used on any type of harmonicas-diatonic, chromatic, octave or tremolo. Playing with this tuning is no more difficult than with others, and manufacturing harmonicas with this tuning is no more difficult than any other existing harmonicas, and consists only in the change of order of the key tuning for the reeds.

### DETAILED DESCRIPTION OF THE INVENTION

My invention—harmonica accordion—consists of two parts. The first part, tuning of the instrument, is a true innovation and can be used in itself for all types of harmonicas without the second part. The second part consists of connection of the second bass body to the harmonica—probably is not an innovation and does not have much sense of self. However, an assemblage of two parts together gives the instrument a completely new quality, allowing solo, full accompaniment and their combination.

### 1. Tuning of Instrument

Configuration of the harmonica accordion is a cyclic sequence of sounds, arranged in the following intervals from each other: tone, tone, semitone, tone, tone, semitone, etc. This configuration can be generally shown using the conventional way of visualizing harmonicas'configuration which is demonstrated on Drawing 1.

I showed on Drawing 1 configuration from note C. It can be seen that the sequence of intervals between adjacent sounds is such as I have described above.

Now I will show what this arrangement of notes gives to the harmonica in practice. As an example, and to simplify my explanation I will use 12-hole harmonica which is demonstrated on Drawing 2.

In the Drawing 2 the Yellow colour indicates the tonic of major triad, which you can play, if you take this (yellow) note + two holes up on the scales. Therefore, taking three notes simultaneously on inhalation or exhalation from such hole, we will get major triad. It is easy to see that if we take four notes, we get the dominant sept chord. Green colourmarked holes are, by analogy, the minor triad tonics. By adding to them a forth note we get either Min7 or Ma6 chord, depending on the musical context. Finally, the holes shown with white colour are those, from which diminished triads can be taken the same way. When adding the fourth hole we have either semi diminished sept chord or chord Min6. Thus, we see that all the necessary chord function (and even with some add-ons) are available in this configuration.

Next, I will demonstrate how these chords arranged relative to each other in a key on Drawing 3.

The Drawing 3 is a fragment of the harmonica. For clarity I used the tone of C major. The letter T denotes the hole from which we can take the tonic triad for this key. Accordingly, the letters S and D are designated the holes, from which you can take a subdominant triad and dominant-sept chord for that key. Roman numerals indicate holes which are taken from the II, III and VI steps, expressed by minor chords and step VII, expressed by semi diminished septchords.

Therefore, we can see that this fragment contains all the steps for the chord C major, and the corresponding holes are located compactly, which is convenient for practical use. Similarly, we can consider any major triad in this configuration as tonic, i.e., all tone chords are built around each major triad, which the triad refers to. On the twelve-hole harmonica scheme shown above, we see 8 tonic triads, but in fact it allows accompanying only in 5 keys, since some chords of 3 other keys are outside the range of this harmonica.

I want to emphasise that even the twelve-hole instrument, shown above, is very practical to use and allows to play accompaniment (and, of course, solo) for almost any piece of music in any style. However, it is limited in keys. You can accompany only in keys G, C, F, Bb and Eb. To get all the keys it is required to increase the number of holes. The full harmonica accordion will look like shown on Drawing 4.

Shown on Drawing 4 is a tuning of the instrument with 23 holes, although it is clear that to get all the chords only 19 holes is enough. But if we look closely at the above diagram, we will see that the “cutting off” the holes from one or the other side will result in inconvenience to accompany either in the key C (if the “cut off” is on the right), or in the key F (if it is on the left). The corresponding holes of the chords required for these tones will be too far apart. So the full instrument must have 23 holes.

It is also clear that if the harmonica has a sequence of holes with tones rising uniformly, the range of the instrument will be more than seven octaves. Therefore, if the bottom sound is B of the minor octave, then the top is D of the seventh octave. It is obvious that such a harmonica is unlikely to be practical, and the accompaniment in upper body will not sound at all. To solve this problem, I used the inversion, i.e. to start again at certain point from low to high tone as demonstrated on Drawing 5.

On the Drawing 5 I used scientific notation of octaves. As can be seen, the harmonica looks like consisting of two parts. The first starts from B of the minor octave and ends with A # of the third octave. Then the inversion follows and the second part begins again from B of the minor octave and ends with D of the fourth octave. Note, the chord inversion does not affect the chords structure, and the range of both parts of the harmonica—over 3 octaves—more than enough for solo play.

Naturally my examples shown above for tuning of the 12-hole and full harmonicas do not exhaust all the possibilities of using this tuning. I have just presented the tuning that I used, and which usability has been tested by me. In fact, harmonica accordion can be made with any number of holes, tuning it from any note with any set of keys, depending on the musical tasks and taste of the performer. I think however, that instrument with less than 10-11 holes is not appropriate to make, since it will have a very limited capacity.

I must also mention the possibilities of the harmonica accordion for solo play. Only the upper body is used for solo play. It is easy to see that the interval between sounds for any two adjacent holes is no more than one tone. This means that using the technique of bends and overbends (or valve bends) one can play the chromatic scale on the harmonica, as on an ordinary harmonica with the Richter tuning. The former is even more convenient, since it does not require more than a semitone bends.

But even when using only pure tones, each key on the harmonica accordion has a range of a little more than one octave. As an example I shown this for C major key on Drawing 6.

I highlighted on Drawing 6 in yellow the continuous sequence of notes included in this key. As you can see, it starts with a step V (note G) and ends at the step VI in the next octave (note A). For any other key it will be similar. In the Drawing 7 I highlighted in yellow G major key.

As we can see on Drawing 7, it also begins with step V (note D) and ends with VI step through one octave. In this range—octave+one step—you can play a lot of tunes, without using the technique of bends and overbends that is certainly convenient for learning to play the instrument by the beginners who are not familiar with this technique. In addition, any tune is very easy to transpose practically into any other key on the harmonica accordion. Due to the fact that the instrument tuning is cyclical, and the order of the tones on it is repeated every three holes, to transpose the melody by one tone, it is enough to play it by shifting in three holes either way. To transpose the melody in a quint (or quart) it is necessary to reverse breaths and move the tablature to a single hole to the left (or two holes to the right).

### 2. The Secondbody

In my opinion to be able to use the harmonica as a self-accompanying instrument just the presence of all the chords is still not enough. It is also important that chords are in the same tessitura, i.e. would not be too scattered over the range. It is also important that the chords would not be in too higher range, since this can get in the way of the solo. That is, firstly, they should not be in the too high register; it is desirable a clearly pronounced bass to be also present. And, secondly, the chords should not also be too much spread in range with respect to each other; on the contrary, it is desirable that they “flow” into one another, forming a merged voicing. As can be seen, this is impossible in the proposed tuning; each chord rigidly fixed in the range from minor to the 4th octaves i.e. some chords are in the lower register, while the others in the upper one, and it is impossible “to move” any chord into other register.

To compensate for this shortcoming, I added a second body for bass. It is located directly below the first one, so that the vertical holes of the upper body are located directly above the corresponding second body holes, i.e. the first hole of the upper body is exactly over the first one of the bottom body and so on. The way bodies are connected to each other I will describe below. The point of such co-location is to be able to simultaneously play sounds from the holes corresponding to each other in bothbodies.

Tuning of the lower body is exactly the same as in the top one, but its notes are in the range of the small and first octaves, being bass notes for the chords of the upper body, which is demonstrated on Drawing 8.

Exceptions, as can also be seen on the Drawing 8, are those sections of the upper body, which notes are in the first and minor octaves. At the corresponding lower body sections notes are tuned an octave up.

Therefore, using holes of both bodies at the same time for playing cords, we always get a chord in a wide range (two octaves or more) with bass range from minor and the first octaves. The upper chord may be in the range of two octaves—the second and third. Roughly the same thing happens when we are accompanying by guitar. Of course, with the harmonica accordion we have much less freedom in the chords variations and their configurations. However, accompanying on this instrument sounds quite convincing.

When attaching the lower body, it is important to take into account its spatial arrangement. As mentioned above, its holes must be located under the corresponding holes of the upper body. The front part of the top plate of the lower body is attached to the front of the bottom cover of the upper body so that inside view the bodies form an angle of 15-30 degrees, and the front part of the lower body is shifted to the middle of the top one by 0.5-2 cm. The Drawing 9 I refer to have such a wide range because within it the instrument is operating well and convenient for playing. The angle between the boards is required in order for the reeds of the top plate of the lower body to freely oscillate. A shift of the lower body to the middle of the upper one is needed to easily grab only the upper board with mouths when playing solo.

The method of attachment of the lower board can vary and depends on the type of harmonica, material and design of covers and so on. Again, the double body for harmonica is not an innovation and has been used previously. For the harmonica accordion I suggest screwing the bottom cover of the upper body with screws that pass through the top plate and body of the lower body to the bottom plate of bottom cover. Rectangular incision should be made in the cover in order to prevent it from deformation by the screws. This mount provides a tight fit of the cover of the upper body to the lower one and allows taking apart the top body off for cleaning and repairing, independent of the lowerone.

1. Harmonica Accordion is a musical instrument analogical to the conventional harmonicas by its design, appearance and playing technique, however, due to a different arrangement of notes and case structure, compared to the existing harmonics, it allows to play not only solo, but also accompaniment in any key, and a combination of both techniques.

2. The notes arrangement, which provides such an opportunity, represents a cyclic sequence of intervals between adjacent notes i.e. semitone-tone-tone-semitone-tone-tone and so on.

3. The notes sequence, as described in the Point 2, can be arranged from any notes and any point of the cyclic sequence and used in all known types of harmonicas in conjunction with the subsequent Points or as it is.

4. The case structure consists of two bodies connected to each other with a tight seal. The bottom body is fixed to the upper one with 0.5-2 cm shift forward and with angle of 15-30 degrees with respect to it so that the lower body's holes are located just below their respective holes on the upper one.

5. The reeds in the lower body are configured to the same notes as the upper one, but in the range of the first and minor octaves, thus differing from the configuration of the upper body by one, two or three octaves.

6. With the combination of all the previous Points we get a new instrument analogical to the common harmonica it its design and playing technique, allowing however to play not only solo but also a full accompaniment and a combination of both at the same time.
